(19) United States
(12) Patent Application Publication
(10) Pub. No.: US 2008/0270919 A1
(43) Pub. Date: Oct. 30, 2008

(54) Context Based Software Layer

(76) Inventors: Richard L. Kulp, Cary, NC (US); Gili Mendel, Cary, NC (US); Joseph R. Winchester, Hursley (GB)

Correspondence Address: LAW OFFICE OF JIM BOICE, 3839 BEE CAVE ROAD, SUITE 201, WEST LAKE HILLS, TX, 78746, US

(21) Appl. No.: 11/741,171

(22) Filed: Apr. 27, 2007

(51) Int. Cl. G06F 3/00

(52) U.S. Cl. 715/762

(57) ABSTRACT

A computer-implementable method, system and computer-readable medium for establishing and utilizing a widget-centric context-based layer are presented. In a preferred embodiment, the computer-implemented method includes a computer detecting a mouse hover over a visual control that is displayed on a visual layer canvas. In response to determining that the visual control is supported by a context layer, the computer displays the visual control and component icons on a context layer canvas, wherein the context layer includes elements from both an upper visual layer and a lower component layer, and wherein the component icons are associated with respective components from the lower component layer. The computer then receives a user input that selects one or more of the component icons, thus permitting associated components to be edited.

### BACKGROUND OF THE INVENTION

The present invention relates in general to the field of computers and similar technologies, and in particular to software utilized in this field. Still more particularly, the present disclosure relates to software development.

A Graphical User Interface (GUI) builder utilizes a “Canvas” as a single placeholder for GUI-parts. A user drops or creates these GUI-parts on the Canvas (from a palette, a wizard, or other sources), and use various visual queues (or helper views and dialogs) to manipulate and configure these elements. GUI-parts can be placed on top of other GUI-parts to build a complete GUI.

Java Visual Editor (JVE) is one type of GUI Builder. JVE enables a user to build a Java GUI by dropping widgets on the Canvas in a hierarchy view. The JVE's GUI parts may be widgets (components) that a computer user interacts with, such as a window, a text field, or a check box. Visual components are specific to a particular widget toolkit (e.g., Microsoft Foundation Classes (MFC) on the Windows™ platform, Swing™ for Java™, and Standard Widget Toolkit (SWT) for Eclipse™). Typically these widgets are quite light in functionality and concern themselves with presentation. Thus, the logic about how the widget's data is read by an underlying component must be provided by supplemental logic. A table, for example, has a set of properties specifying features such as border, background color, scroll visibility and so forth. The developer however, having laid out the widgets and set the properties, must then write code that populates the content of the table. This code includes instructions on such topics as binding data to a widget, how data validation occurs, cell editing, column data conversion, filtering, sorting, paging logic and so forth. Thus, the widget is presented on an upper layer canvas, but the features and code that support the widget are on another lower layer canvas, which must be toggled to in order for a user to know what functionality and protocol are being used with that particular widget.

For example, consider the GUI 102 shown in FIG. 1A. Within GUI 102 are four widgets 104a-d, which may be, for example, dialog boxes used to inter data into an underlying table that is found in a lower layer (not shown). When a user switches to a lower layer canvas to view the underlying table from the lower layer, however, it is difficult for the user to know which visual and non-visual information shown on the lower layer canvas relates to a particular widget 104 that is displayed in the upper layer canvas depicted as GUI 102. That is, as shown in FIG. 1B, the GUI 106 displays various underlying codes 108a-d. However, there is no clear cue in the code that describes which of the underlying codes 108a-d is linked with a particular widget from the widgets 104a-d shown in FIG. 1A.

### SUMMARY OF THE INVENTION

To address the condition described above, presently disclosed are a computer-implementable method, system and computer-readable medium for establishing and utilizing a widget-centric context-based layer. In a preferred embodiment, the computer-implemented method includes a computer detecting a mouse hover over a visual control that is displayed on a visual layer canvas. In response to determining that the visual control is supported by a context layer, the computer displays the visual control and component icons together on a context layer canvas, wherein the context layer includes elements from both an upper visual layer and a lower component layer, and wherein the component icons are associated with respective components from the lower component layer. The computer then receives a user input that selects one or more of the component icons. In response to the user input selecting one or more of the component icons, the computer then presents a property sheet on the context layer canvas, wherein the property sheet contains user-editable properties of a component that is associated with a selected component icon. The computer can then receive a user editing input that edits the user-editable properties.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1A depicts a prior art Graphical User Interface (GUI) showing multiple widgets on an upper-layer visual layer of an Integrated Development Environment (IDE);

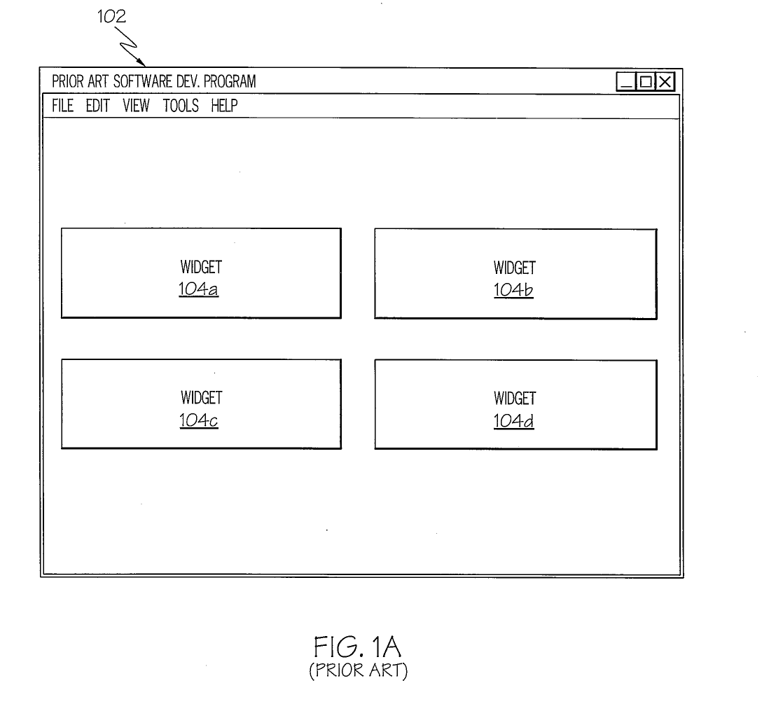

FIG. 1B depicts a GUI showing different underlying code for widgets shown in FIG. 1A, but without clear correlation cues;

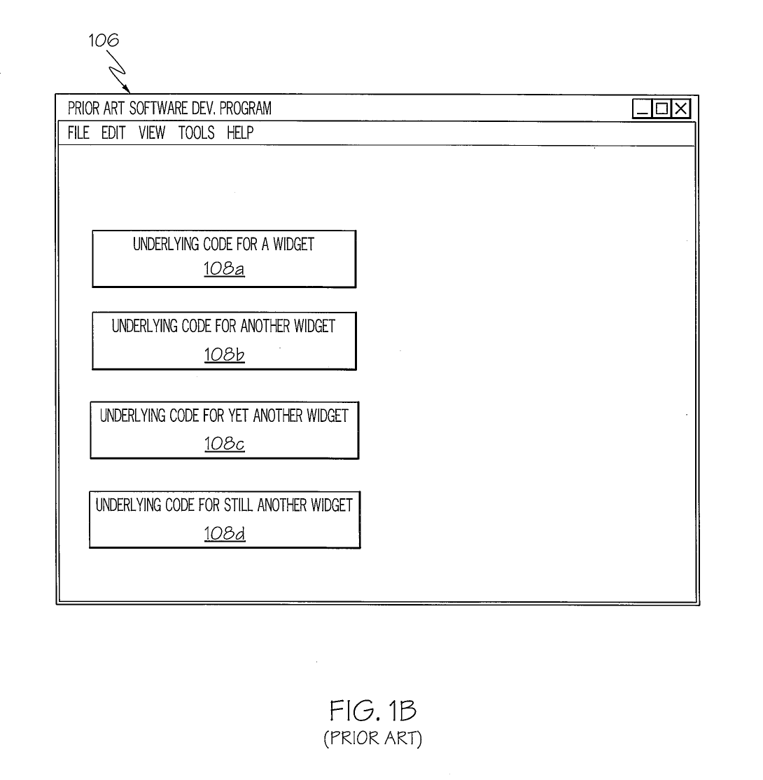

FIG. 2 illustrates a context layer in a novel context-layer-based software development program;

FIG. 3 is a high-level flow-chart of exemplary steps taken to create a widget in the novel context-layer-based software development program;

FIG. 4 depicts the widget, which has been created in the novel context-layer-based software development program, being displayed on a visual layer canvas;

FIG. 5 depicts the widget, which has been created in the novel context-layer-based software development program, being displayed on the context layer canvas while dynamically displaying visual and non-visual support components of the widget;

FIG. 6 is a high-level flow-chart of exemplary steps taken to display and manipulate support components of the widget; and

FIG. 7 depicts an exemplary computer in which the present invention may be implemented.

### DETAILED DESCRIPTION OF THE PREFERRED EMBODIMENT

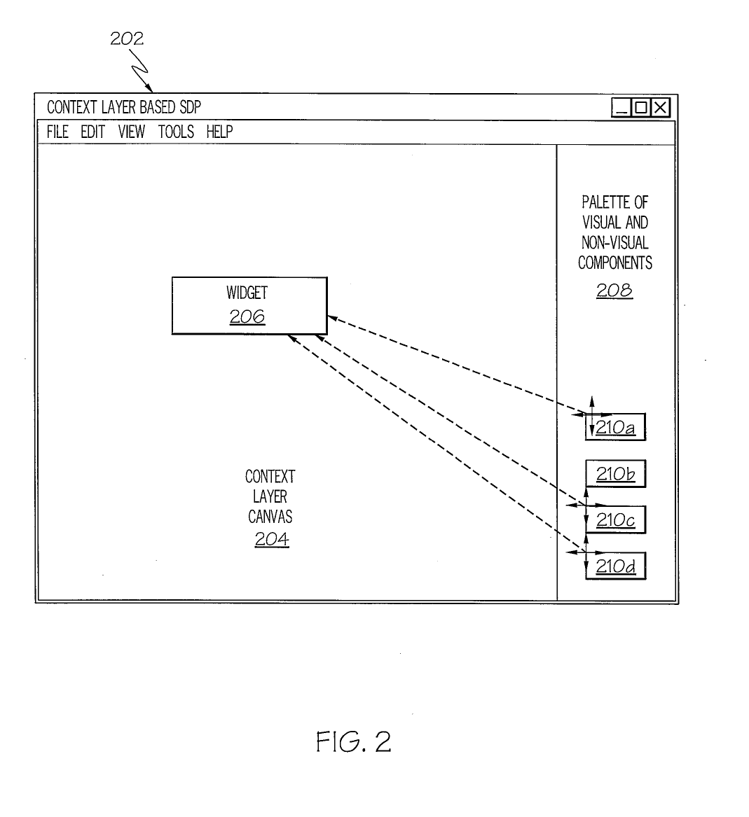

With reference now to FIG. 2, an exemplary GUI 202 is depicted with a novel context layer canvas 204 that may be used to construct the functionality of a widget. As described herein, context layer canvas 204 is able to display and manipulate widgets from a visual upper layer, while contemporaneously displaying visual and non-visual components, from a lower layer, that are associated with a specific widget. Thus, a widget 206 is displayed (e.g., after being drag-and-dropped from a palette of widgets—not shown) on context layer canvas 204. A palette of visual and non-visual components 208 is also displayed on the GUI 202. The palette of visual and non-visual components 208 includes icons that are associated with multiple visual and non-visual components, depicted in an exemplary manner as component icons 210a-d.

Assume for exemplary purposes that widget 206 is a data input widget that accepts data for entry into an underlying database, and that the underlying database will be used to populate some or all of an underlying table. In this example, the underlying table could be a visual component (represented by component icon 210a), since it can be visually displayed according to predefined criteria and protocols. In the “table” example, an example of a non-visual component includes, but is not limited to, a database (represented by component icon 210c), which may be a database of enterprise employees that is used to populate the table; and a binder (represented by component icon 210d), which includes instructions, passwords and protocol used to bind (logically associate) the table with the database. Other types of non-visual components include, but are not limited to, software that defines or enables schema definitions; CRUD (create, retrieve, update, delete) methods for documents; search functions; data format conversion software logic; sorting operations; document manipulation and editing; event handling; etc. By dragging component icons 210a, 210c, and 210d onto the displayed widget 206, the functionality, information, protocol, etc. associated with the represented components is now associated with widget 206.

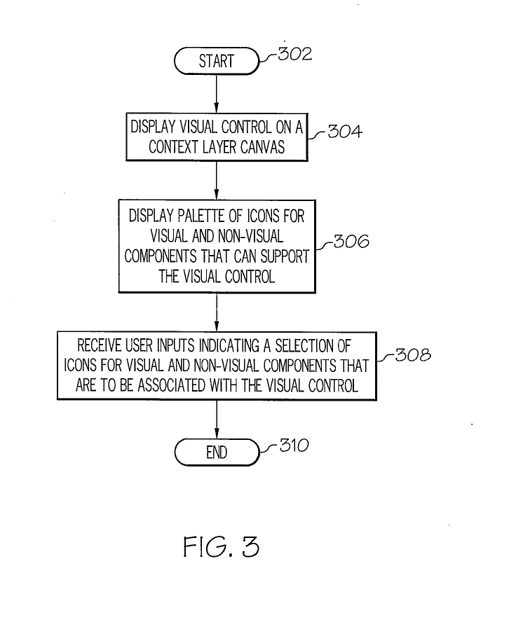

Referring then to FIG. 3, a flow-chart of exemplary steps visually shown in FIG. 2 is presented. After initiator block 302, a visual control (e.g., widget 206 shown in FIG. 2) is displayed on a context layer canvas (block 304). Note that the context layer canvas is able to display information from an intermediate novel context layer, which logically is between an upper visual layer and a lower data/protocol layer, and thus has access to both the upper and lower layers.

As described in block 306, a palette of icons associated with visual and non-visual components, which may be used with the displayed widget, is also displayed. These visual and non-visual components may be from any of the many component frameworks that augment toolkit widget functionality, such as Microsoft's™ Design Time Controls (DTC), Java Network Desktop Components (JNDC)), or Java Server Faces (JSF) controls. These frameworks make it easier for a developer to create and configure high fidelity and functionally rich controls. These frameworks work by providing wrapper or helper elements that decorate the native widgets and augment their functionality. As an example, one GUI framework provides the Standard Widget Tool (SWT) as the native widget toolkit, which provides JFace components as the logical decorators. That is, SWT is a widget set and graphics library that is integrated with a native window system, but with an Operating System (OS)-independent Application Program Interface (API). JFace is a User Interface (UI) toolkit that is implemented though SWT. JFace sits partially “on top of” SWT to simplify common UI programming tasks, but does not hide SWT. Thus, JFace components augment the functionality of the native SWT components and add support for data binding, validation and other logic required to implement complete functionality required for a typical business logic application. A JFace table-viewer component, as an example, includes both the visual widget (shown in FIG. 2 as widget 206) as well as non-visual controllers, such as binders, databases, etc.

Returning again to FIG. 3, a user then drag-and-drops one or more of the component icons onto the displayed widget, thus imparting the functionality of the selected component(s) onto displayed widget (block 308). The process ends at terminator block 310.

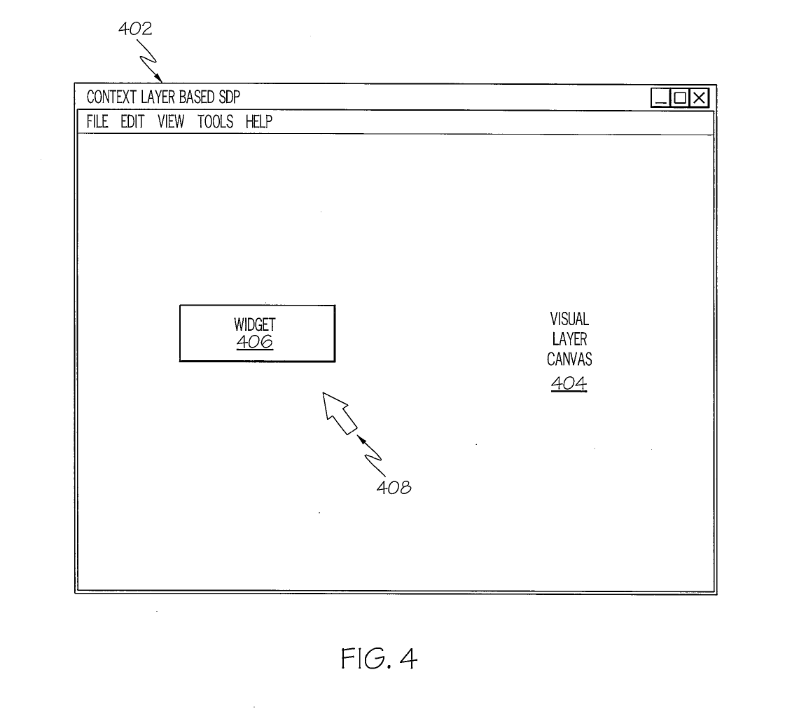

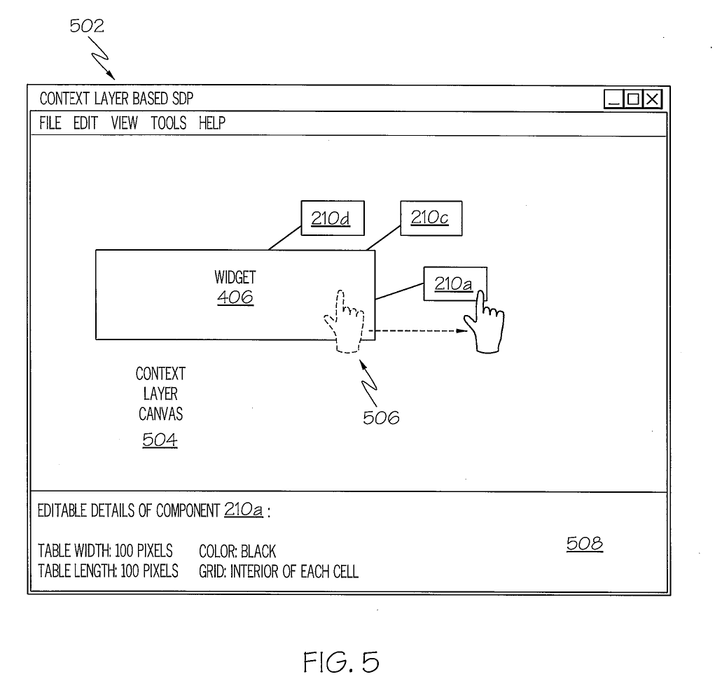

Referring now to FIG. 4, a GUI 402 is depicted in which the visual layer canvas 404 displays a widget 406, which is the same as widget 206 shown in FIG. 2, but has now been empowered with the functionality of components 210a, 210c, and 210d as described above. Note that a cursor 408 is not over widget 406. However, as shown in FIG. 5, when cursor 408 hovers over widget 406, cursor 408 changes appearance and functionality as shown by active cursor 506. Thus, as shown in FIG. 5, by hovering active cursor 506 over widget 406, display of the widget 406 is automatically moved to a context layer canvas 504, on which component icons 210a, 210c and 210d are displayed, preferably with lines showing the associations of the widget 406 to the variously depicted components. Thereafter, by hovering active cursor 506 over one of the component icons (e.g., component icon 210a), then information associated with the component represented by component icon 210a appears within a property sheet window 508. For example, assume that component icon 210a is a table visual component that is associated with component icon 210a. By clicking component icon 210a, editable elements of the table (e.g., size, color, format, etc.) are displayed in the property sheet window 508. These displayed properties are editable directly from the context layer canvas 504, thus avoiding problems inherent with toggling back and forth between a visual layer canvas and an underlying layer canvas.

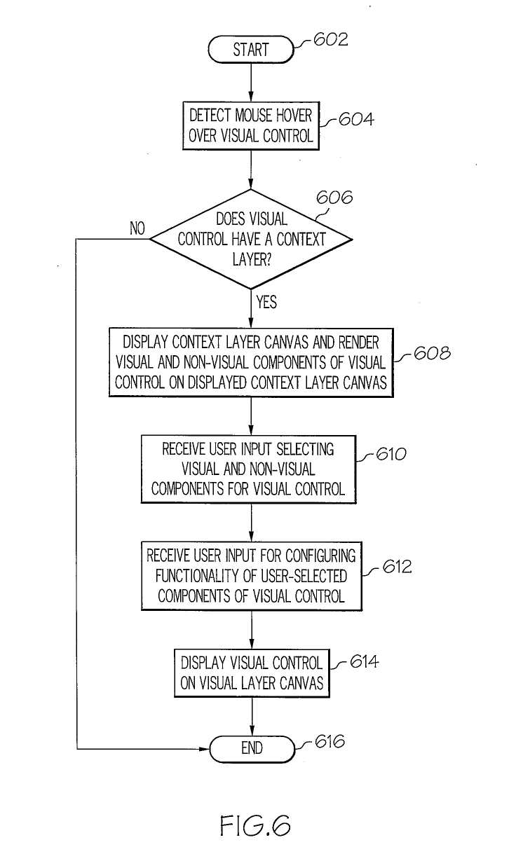

With reference now to FIG. 6, a flow-chart of exemplary steps taken to utilize the context layer canvas shown in FIG. 5 is presented. After initiator block 602, a computer detects a mouse hover over a visual control such as the widget 406 described in FIG. 5 (block 604). As shown in query block 606, a determination is made as to whether the widget being hovered over has a context layer. That is, a determination is made as to whether the visual control is supported by the functionality of a context layer canvas as described above. If so, then the visual control is displayed on a context layer canvas (block 608). When the computer system detects that a user has hovered a cursor over the visual control, then the visual and/or non-visual components pop-up in a manner such as that described above. As the user selects various components that have been previously associated with the widget (block 610), the property sheet window appears, thus allowing the user to edit, configure, delete, etc. the underlying component associated with the selected component icon (block 612). After the user has completed any configuration of the selected components, the widget is again displayed on the visual layer canvas (block 614), in order to permit normal operation of the widget. The process thus ends at terminator block 616.

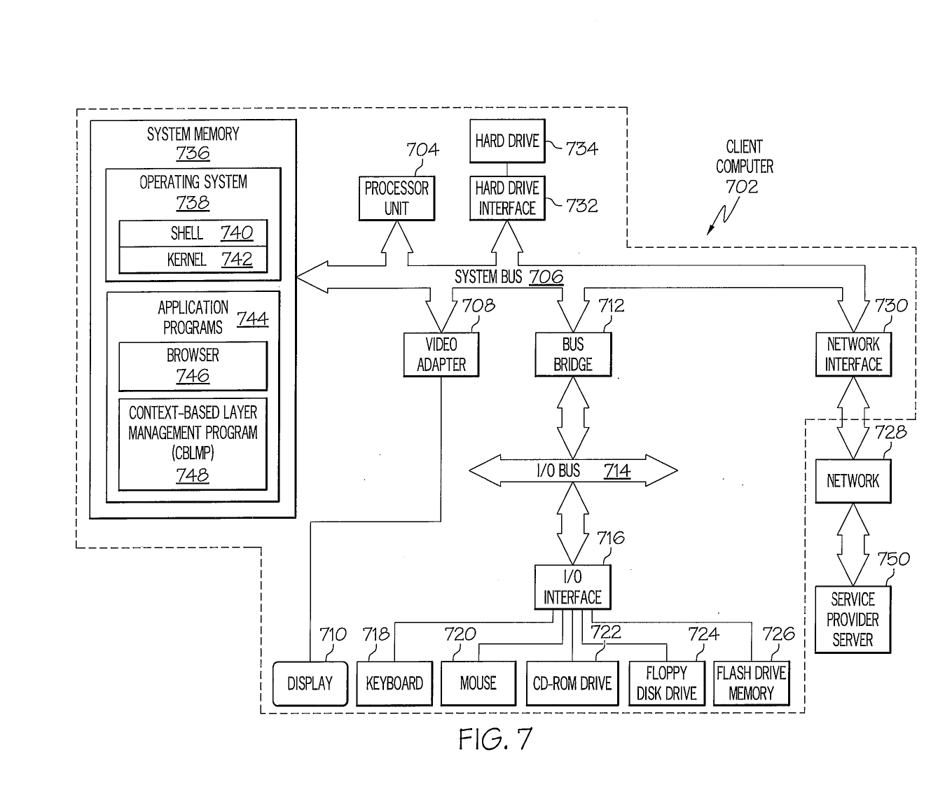

With reference now to FIG. 7, there is depicted a block diagram of an exemplary client computer 702, in which the present invention may be utilized. Client computer 702 includes a processor unit 704 that is coupled to a system bus 706. A video adapter 708, which drives/supports a display 710, is also coupled to system bus 706. Content that is presented in display 710 includes, but is not limited to, any GUI or UI described herein. System bus 706 is coupled via a bus bridge 712 to an Input/Output (I/O) bus 714. An I/O interface 716 is coupled to I/O bus 714. I/O interface 716 affords communication with various I/O devices, including a keyboard 718, a mouse 720, a Compact Disk-Read Only Memory (CD-ROM) drive 722, a floppy disk drive 724, and a flash drive memory 726. The format of the ports connected to I/O interface 716 may be any known to those skilled in the art of computer architecture, including but not limited to Universal Serial Bus (USB) ports.

Client computer 702 is able to communicate with a service provider server 750 via a network 728 using a network interface 730, which is coupled to system bus 706. Network 728 may be an external network such as the Internet, or an internal network such as an Ethernet or a Virtual Private Network (VPN). Service provider server 750 may utilize a similar architecture design as that described for client computer 702.

A hard drive interface 732 is also coupled to system bus 706. Hard drive interface 732 interfaces with a hard drive 734. In a preferred embodiment, hard drive 734 populates a system memory 736, which is also coupled to system bus 706. Data that populates system memory 736 includes client computer 702's operating system (OS) 738 and application programs 744.

OS 738 includes a shell 740, for providing transparent user access to resources such as application programs 744. Generally, shell 740 is a program that provides an interpreter and an interface between the user and the operating system. More specifically, shell 740 executes commands that are entered into a command line user interface or from a file. Thus, shell 740 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 742) for processing. Note that while shell 740 is a text-based, line-oriented user interface, the present invention will equally well support other user interface modes, such as graphical, voice, gestural, etc.

As depicted, OS 738 also includes kernel 742, which includes lower levels of functionality for OS 738, including providing essential services required by other parts of OS 738 and application programs 744, including memory management, process and task management, disk management, and mouse and keyboard management.

Application programs 744 include a browser 746. Browser 746 includes program modules and instructions enabling a World Wide Web (WWW) client (i.e., client computer 702) to send and receive network messages to the Internet using HyperText Transfer Protocol (HTTP) messaging, thus enabling communication with service provider server 750.

Application programs 744 in client computer 702's system memory also include an Context-Based Layer Management Program (CBLMP) 748, which includes logic for implementing the steps and UI's described above in FIGS. 2-6. In a preferred embodiment, service provider server 750 also has a copy of CBLMP 748, which may be executed by or downloaded from service provider server 750, as described below. In one embodiment, client computer 702 is able to download CBLMP 748 from service provider server 750.

The hardware elements depicted in client computer 702 are not intended to be exhaustive, but rather are representative to highlight essential components required by the present invention. For instance, client computer 702 may include alternate memory storage devices such as magnetic cassettes, Digital Versatile Disks (DVDs), Bernoulli cartridges, and the like. These and other variations are intended to be within the spirit and scope of the present invention.

As noted above, CBLMP 748 can be downloaded to client computer 702 from service provider server 750. This deployment may be performed in an “on demand” basis manner, in which CBLMP 748 is only deployed when needed by client computer 702. Note further that, in another preferred embodiment of the present invention, service provider server 750 performs all of the functions associated with the present invention (including execution of CBLMP 748), thus freeing client computer 702 from using its resources. In another embodiment, process software for the method so described may be deployed to service provider server 750 by another service provider server (not shown). In yet another embodiment, ICEE 748 may be implemented through the use of a browser based application such as a Rich Internet Application (RIA). This RIA may be implemented in browser 746, preferably through the use of JavaScript such as AJAX (Asynchronous JavaScript using XML).

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, presently disclosed are a computer-implementable method, system and computer-readable medium for establishing and utilizing a context-based layer. Note that the context-based layer is widget-centric, since the context-based layer can be called up by any widget that is supported by the context-based layer described herein. In a preferred embodiment, the computer-implemented method includes a computer detecting a mouse hover over a visual control that is displayed on a visual layer canvas. In response to determining that the visual control is supported by a context layer, the computer displays the visual control and component icons on a context layer canvas, wherein the context layer includes elements from both an upper visual layer and a lower component layer, and wherein the component icons are associated with respective components from the lower component layer. The computer then receives a user input that selects one or more of the component icons. In response to the user input selecting one or more of the component icons, the computer then presents a property sheet on the context layer canvas, wherein the property sheet contains user-editable properties of a component that is associated with a selected component icon. The computer can then receive a user editing input that edits the user-editable properties.

Note that the method steps described herein may be implemented in a computer system, and may further be executed by instructions that are stored in a computer-readable medium.

In another embodiment, in which the methods described herein are performed by software that is stored on a computer-readable medium, the computer-readable medium is a component of a remote server, and the computer executable instructions are deployable to a client computer and/or a supervisory computer from the remote server. This deployment may be provided by a service provider to a customer computer (e.g., the client computer and/or the supervisory computer) on an on-demand basis.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
detecting a mouse hover over a visual control that is displayed on a visual layer canvas;
in response to determining that the visual control is supported by a context layer, displaying the visual control and component icons on a context layer canvas, wherein the context layer includes elements from both an upper visual layer and a lower component layer, and wherein the component icons are associated with respective components from the lower component layer;
receiving a user input selecting one or more of the component icons;
in response to receiving the user input selecting one or more of the component icons, presenting a property sheet on the context layer canvas, wherein the property sheet contains user-editable properties of a component that is associated with a selected component icon; and
receiving a user editing input that edits the user-editable properties.

2. The computer-implementable method of claim 1, further comprising:
in response to the user-editable properties being edited, returning display of the visual control to the visual layer canvas.

3. The computer-implementable method of claim 1, wherein the visual control is a data input widget, and wherein the selected component icon is associated with a table component for the visual control.

4. The computer-implementable method of claim 1, wherein the context layer for the visual control is established by:
displaying the visual control on a context layer canvas;
displaying a palette of visual and non-visual components that can support the visual control; and
receiving a user input that associates one or more of the visual and non-visual components with the visual control.

5. A system comprising:
a processor;
a data bus coupled to the processor;
a memory coupled to the data bus; and
a computer-usable medium embodying computer program code, the computer program code comprising instructions executable by the processor and configured for:
detecting a mouse hover over a visual control that is displayed on a visual layer canvas;
in response to determining that the visual control is supported by a context layer, displaying the visual control and component icons on a context layer canvas, wherein the context layer includes elements from both an upper visual layer and a lower component layer, and wherein the component icons are associated with respective components from the lower component layer;
receiving a user input selecting one or more of the component icons;
in response to receiving the user input selecting one or more of the component icons, presenting a property sheet on the context layer canvas, wherein the property sheet contains user-editable properties of a component that is associated with a selected component icon; and
receiving a user editing input that edits the user-editable properties.

6. The system of claim 5, wherein the instructions are further configured for:
in response to the user-editable properties being edited, returning display of the visual control to the visual layer canvas.

7. The system of claim 5, wherein the visual control is a data input widget, and wherein the selected component icon is associated with a table component for the visual control.

8. The system of claim 5, wherein the context layer for the visual control is established by executable instructions for:
displaying the visual control on a context layer canvas;
displaying a palette of visual and non-visual components that can support the visual control; and
receiving a user input that associates one or more of the visual and non-visual components with the visual control.

9. A computer-usable medium embodying computer program code, the computer program code comprising computer executable instructions configured for:
detecting a mouse hover over a visual control that is displayed on a visual layer canvas;
in response to determining that the visual control is supported by a context layer, displaying the visual control and component icons on a context layer canvas, wherein the context layer includes elements from both an upper visual layer and a lower component layer, and wherein the component icons are associated with respective components from the lower component layer;
receiving a user input selecting one or more of the component icons;
in response to receiving the user input selecting one or more of the component icons, presenting a property sheet on the context layer canvas, wherein the property sheet contains user-editable properties of a component that is associated with a selected component icon; and
receiving a user editing input that edits the user-editable properties.

10. The computer-usable medium of claim 9, wherein the computer executable instructions are further configured for:
in response to the user-editable properties being edited, returning display of the visual control to the visual layer canvas.

11. The computer-usable medium of claim 9, wherein the visual control is a data input widget, and wherein the selected component icon is associated with a table component for the visual control.

12. The computer-usable medium of claim 9, wherein the context layer for the visual control is established by computer executable instructions for:
displaying the visual control on a context layer canvas;
displaying a palette of visual and non-visual components that can support the visual control; and
receiving a user input that associates one or more of the visual and non-visual components with the visual control.

13. The computer-useable medium of claim 9, wherein the computer executable instructions are deployable to a client computer from a server at a remote location.

14. The computer-useable medium of claim 9, wherein the computer executable instructions are provided by a service provider to a customer on an on-demand basis.
